(19) United States
(12) Patent Application Publication
(10) Pub. No.: US 2018/0241237 A1
(43) Pub. Date: Aug. 23, 2018

(54) Mobile Electric Storage Device

(71) Applicant: Harald Kemmann, Velbert (DE)

(72) Inventor: Harald Kemmann, Velbert (DE)

(73) Assignee: innogy Innovation GmbH, Essen (DE)

(21) Appl. No.: 15/955,944

(22) Filed: Apr. 18, 2018

Related U.S. Application Data
(63) Continuation of application No. PCT/EP2016/069620, filed on Aug. 18, 2016.

(30) Foreign Application Priority Data
Oct. 22, 2015 (DE) 10 2015 117 978.4

(51) Int. Cl. H02J 7/00; H02J 50/10; H02J 7/02; H01M 10/052; H01M 12/06; H01M 10/44; H01M 10/48

(52) U.S. Cl. CPC H02J 7/0068; H02J 50/10; H02J 7/025; H02J 7/0042; H01M 2220/30; H01M 12/06; H01M 10/44; H01M 10/488; H01M 10/052

(57) ABSTRACT

Embodiments of a mobile electric storage device are provided. The mobile electric storage device includes a housing, a battery, an inverter electrically connected to the battery, a power outlet electrically connected to the inverter, a charge controller connected to the battery, and a power inlet which is connected to the charge controller. The battery, inverter, power outlet, and charge controller are all arranged in the housing. A cost-effective circuit system can be provided in that the power inlet and the charge controller are configured for higher electrical outputs than the inverter and the power outlet.

### CROSS-REFERENCE TO RELATED PATENT APPLICATIONS

This patent application is a continuation of PCT/EP2016/069620, filed Aug. 18, 2016, which claims priority to German Application No. 10 2015 117 978.4, filed Oct. 22, 2015, the entire teachings and disclosure of which are incorporated herein by reference thereto.

### FIELD OF THE INVENTION

The subject matter relates to a mobile electric storage, to a system comprising a mobile electric storage, and to a method for charging a mobile electric storage device.

### BACKGROUND OF THE INVENTION

Up to now, access to electrical energy has generally been dependent on location. The current is transported from power stations to loads via distribution networks. In the case of the load, the current in the home environment is supplied via a low-voltage network at 0.4 KV, in the industrial environment, supplies at 1 KV and higher are possible.

In particular for household-related power consumption, generally only low electrical outputs are required. The price of electricity is generally composed of firstly a price for generation and secondly of cost allocations and taxes. As a result of the increasing number of power stations in the area of alternative energies, such as photovoltaics and wind power, it is necessary to expand the distribution network. The resulting costs are allocated to the price of electricity. However, the producer price has considerably decreased in recent years.

In order to gain independence from network charges, it would be helpful to be able to provide electrical energy in normal household amounts in any location without having to use the distribution network.

### BRIEF SUMMARY OF THE INVENTION

The subject matter thus addresses the object of providing a power supply with electrical energy which is independent of the electric power distribution network. This object is achieved, according to the subject matter by a mobile electric storage device as described herein.

By means of the mobile electric storage device according to the subject matter, access to electrical energy is not dependent on location. The electric storage device can comprise a battery. The battery can preferably be charged in the location where the electric power is generated, in particular near the power station, preferably in a large-scale power station. This charging can take place in an automated and scalable process so that a plurality of electric storage devices can be charged at the same time. The then charged storage devices can be stored and sold to the end clients by retail.

On site, the client can then use the mobile storage device like a conventional socket if at least one inverter is provided in the mobile storage device. By means of the inverter, it is possible to provide the electrical energy stored in the battery under standard conditions for each region. This means that, for example for mobile storage devices for Germany, the inverter provides an output voltage of 230 V at 50 Hz. For other regions, for example output voltages of 230 V at 60 Hz or 115 V at 60 Hz or the like can be provided. In other words, the inverter can be adapted to the external conditions in each case and can provide the electrical energy from the battery at a power outlet, via which the electrical energy can be obtained as from a conventional socket.

For this purpose, the electric storage device is provided with a housing and a battery arranged in the housing. The battery is connected to a power outlet via an inverter. A power outlet can be understood to mean that said outlet is capable of transferring electric power and electrical energy from the battery to a load. The power outlet can be contactless or contact-based and thus offer different options for transferring the electrical energy from the battery.

At the same time, to make the mobile storage device rechargeable, it is necessary to charge the battery via a charge controller. For this reason, a charge controller is provided in the housing, which controller is connected to the battery. The charge controller is connected to a power inlet. The power inlet can also be contact-based or contactless. Via the power inlet, electric power and thus electrical energy can be transferred from outside the housing into the inside of the housing and stored in the battery via the charge controller.

To promote the distribution of the mobile electric storage devices and thus make said devices independent of the power distribution network, it is necessary for the mobile storage devices to be able to be charged as quickly as possible. Preferably, the storage devices will be charged near a power station. To make this quick charging possible, it is now proposed that the power inlet and the charge controller be configured for higher electrical outputs than the inverter and the power outlet.

This preferred embodiment makes it possible for the mobile storage device to be charged with a higher electrical output than the electrical output which can be obtained from the mobile storage device.

Generally, conventional sockets are protected for an electrical output of from 3 to 4 kW, which means that generally a 16 A fuse protects a 230 V connection. This protection represents the maximum electrical output which can be discharged via the power outlet. The inverter can at least be configured for an electrical output of this type.

For mass deployment of the mobile electric storage device, however, it is necessary for said device to be able to be charged more quickly than it is discharged. In this respect, it is necessary for the electrical energy to be able to be transferred into the battery via the power inlet with a higher electrical output than the electrical output which is provided by the battery via the power outlet. In this respect, the maximum current and the maximum voltage with which the battery can be charged is higher than the maximum current and the maximum voltage at the power outlet. Both the charge controller and the power inlet must be configured for the higher electrical output, that is to say that they must in particular have a higher dielectric strength and a higher current-carrying capacity than in the case of the power outlet.

In particular, the power outlet is configured for electrical outputs of a low-voltage network, for example based on 230 V. In this case, protection against currents of over 16 A can be provided. The power outlet is preferably in the form of a standardised socket, for example according to the Schuko standard or the British standard.

It is also possible for the power outlet to be configured in such a way that it can be connected to a low-voltage network, for example in a household. Thus for example a low-voltage distribution network in a household can be supplied by the mobile electric storage device according to the subject matter. This could be useful for example in the event of a power failure in order to be able to maintain necessary functions in a household.

According to one embodiment, it is proposed that the battery be a lithium-ion battery or a lithium polymer battery. Both battery types are characterised by a high energy density, and therefore even capacities of from 2 to 4 kWh can be achieved in a small installation space with a low weight.

The battery can also be a metal-air battery. Such a battery can be for example a zinc-air battery or an aluminium-air battery.

In the case of an aluminium-air battery, however, it can be necessary to replace the metal cells at intervals when they are exhausted.

As has already been mentioned, the power outlet can be formed by contacts. Such contacts can be provided for example in a socket. Such a socket can be formed according to standard requirements, for example according to the Schuko standard or the British standard or another suitable standard which is used in home installations.

According to one embodiment, it is proposed that a rectifier be arranged in the housing, that the rectifier be electrically connected to the charge controller, and that the power inlet be connected to the rectifier. It is understood that a battery is generally charged with DC voltage. If the charging via the power inlet takes place by means of AC voltage, for example also when charging by means of magnetic induction, it can be necessary for said AC voltage to firstly be rectified in the storage device before it is used to charge the battery. For this reason, a suitable rectifier is provided. The rectifier is generally configured at least for the same electrical output as the power inlet and the charge controller, but at least not for a lower electrical output.

As has been mentioned, the power inlet can be wired or wireless. In particular, the power inlet can be formed by means of electrical contacts. According to one embodiment, the power inlet is in the form of an electrical contact socket. In particular, the power inlet is a direct current inlet, and therefore, by means of a direct current source, it is possible to directly charge the battery without the rectifier. Both a rectifier and a direct current inlet can also be provided cumulatively so that it is possible to charge both with direct current and with alternating current or an alternating magnetic field and, depending on how the current enters the housing of the storage device, the charge controller is energised either by the direct current inlet or by the rectifier.

Since the battery generally has a very high energy density, special protection of the battery is necessary. For manufacturing reasons, it is preferable in this case for the battery, in particular also the inverter and/or a discharging coil to be enclosed in a moisture-tight manner in an enclosure inside the housing. Thus, the components which lead to very high power flows in the event of a short circuit are separately sealed inside the housing in that they are enclosed together. The enclosure is preferably to be provided in accordance with IPX7 to IPX9 according to DIN EN 60529. That is to say that the enclosure is protected against splashing water, preferably even against immersion, so that an electrical short circuit in the region of the battery as a result of ingress of water can be prevented as far as possible. Inside the enclosure, another fuse can additionally be provided so that the battery is protected against an electrical short circuit inside the enclosure.

In order to allow inductive charging, in particular in the case of mass deployment of the mobile storage device, for example in a deposit system, and a plurality of mobile storage devices are to be charged at the same time near a power station, it is advantageous for the power inlet to be in the form of an inductive receiver coil. In this case, it is preferable for the receiver coil to be able to contactlessly receive electrical energy from outside the electric storage device, in particular from outside the housing. The electric power received in this manner results in a current flow through the receiver coil, which current can be transferred to the charge controller. In this case, preferably firstly a rectifier can rectify the current induced in the receiver coil and transfer said current to the charge controller.

The charge controller then controls the charging of the battery in particular according to the state of charge of the battery. By means of the inductive receiver coil, galvanic decoupling is brought about between a power supply arranged outside the housing and a charge controller or rectifier arranged inside the housing. A reverse current is also prevented so that an electrical short circuit cannot be caused on the charging electronics as a result of improper external operation.

According to one embodiment, it is proposed that the power outlet comprise an inductive transmitter coil and an inductive receiver coil which is inductively coupled to the transmitter coil. Proceeding from the battery and the rectifier, firstly the inductive transmitter coil can be provided. This can be provided for example as a discharging coil inside the enclosure. Outside the enclosure, the receiver coil can then be arranged so as to be inductively coupled to the transmitter coil. Inside the enclosure, the transmitter coil can be connected to the inverter and supplied with electric power via the inverter. Outside the enclosure, the electric power which has been converted into an alternating magnetic field by the transmitter coil is received by the receiver coil and converted into electric power. The induced current can be connected to an electrical contact, for example a socket in or on the housing, by means of electric wires.

By providing the transmitter coil and the receiver coil, which are electrically isolated from one another by the enclosure, galvanic decoupling between the electrical contact and the inverter, thus the battery, is possible.

According to one embodiment, it is proposed that a sensor be configured for contactless or contact-based detection of an energy-extraction means arranged on the housing. An energy-extraction means of this type can be for example a coil which is coupled to the discharging coil. The extraction means can also be a plug which is connected to the electrical contacts of the power outlet. When an energy-extraction means is present, the transmitter coil and/or the discharging coil can be supplied with electricity by means of the inverter so that electrical energy can be transferred from the battery to the energy-extraction means.

As soon as the sensor detects that the energy-extraction means is present, the sensor can electrically activate the discharging coil. For this purpose, for example a switch between the battery and the inverter can be closed.

According to one embodiment, it is proposed that a state-of-charge indicator for indicating the state of charge of the battery be arranged on the housing. A state-of-charge indicator of this type can for example also merely indicate whether or not the battery still has sufficient electrical charge to provide the above-mentioned standard voltage at the above-mentioned standard current for a certain period of time, for example 10 seconds, 20 seconds, 1 minute, 10 minutes. The indicator can also indicate for example when the state of charge of the battery falls below 10% of the fully charged state. The indicator can also indicate a current state of charge until the state of charge falls below a certain threshold value.

According to one embodiment, it is proposed that a contactlessly readable memory be arranged in the housing. A wide variety of information about the battery and the mobile storage device can be stored in the memory.

For example, one item of information can be an item of information about the state of charge (SOC) of the battery. It is thus possible to contactlessly read what state of charge the battery has.

The information about the state of charge of the battery and all the other mentioned information can be transmitted for example by means of a wireless communication module, for example a WLAN module, a NFC module, a RFID module or another near-field communication module, for example a Bluetooth module. The mobile storage device can also dial into a home network by means of the communication module. It is also possible for the communication module to be a mobile communications module, by means of which a wide area connection can be established. The mobile storage device can thus transmit for example the information thereof to a central computer. By means of this, it is possible to detect the state of multiple mobile storage devices and derive information about a future requirement therefrom.

For charging and replacing the mobile storage device, for example replacing a worn-out battery, information about the number of charging cycles can be of interest. In this respect, such information can also be stored in the memory.

The duration of the individual charging cycles can also provide information about the state of the battery. Depending on said state, for example a replacement of a mobile storage device from a deposit system can take place.

The extent to which a mobile storage device is actually discharged in operation can also be of interest. For this purpose, it is possible to store for example how much electrical energy the battery has discharged within a discharging cycle or in the entire lifespan thereof.

To evaluate the use of mobile storage devices, for example position data can be of interest. In this respect, position data, thus the progression of position data, can be stored in the mobile storage device. This information can be provided for example with a time stamp. Additional information, inter alia the information listed here, can also be stored with a time stamp so that a progression over time of the respective information can be reconstructed. In this case, for example the discharge of a battery in a specific position at a specific point in time can be reconstructed in order to be able to draw conclusions about the use of the mobile storage device.

A unique address of the mobile storage device can also be present in the memory so that the mobile storage device can be uniquely identified. A unique address or identification of the battery can also be useful when for example batteries in mobile storage devices are replaced. It is then possible to track which batteries are present in which storage device.

Lastly, the storage capacity of the battery can also be filed in the memory so that it is possible to ascertain the applications for which each storage device is suitable. The corresponding information can be contactlessly read or transmitted.

According to one embodiment, it is proposed that the power outlet be configured for an electrical output of up to 3 kW and/or that the power inlet be configured for an electrical output of at least 20 kW, preferably 50 kW, preferably 75 kW. The corresponding configuration takes place by means of the current-carrying capacity and the dielectric strength of the respective components. The charge controller can also be configured for charging with up to 150 C so that the battery can be charged very quickly.

To prevent electrical energy from flowing out of the battery via the power inlet and to also prevent a short circuit occurring at the power inlet, it is proposed that a current flow sensor at the power inlet monitor a direction of current flow. The power inlet can be connected to the battery only when charging the battery, otherwise galvanic separation can be provided. This is possible by detecting the direction of current flow, which must be from the power inlet to the battery, to electrically connect the power inlet to the battery.

For this reason, it is proposed that a switch be arranged at the power inlet, and that the switch break the electrical connection between the power inlet and the charge controller when a power flow from the rectifier to the power inlet is detected by a current flow sensor.

A corresponding arrangement with a switch and/or a current sensor can also be provided at the power outlet between the power outlet and the inverter. In this case, it is possible to allow only a current from the inverter to the power outlet.

According to one embodiment, it is proposed that the battery and the housing be configured in such a way that the storage device has an energy density of at least 4 kWh/dm³. By using metal-air batteries, lithium-ion batteries or lithium polymer batteries and reducing installation spaces for the other electrical components, the stipulated energy density can be achieved.

It can also be expedient for the battery and the housing to be configured in such a way that the storage device has an energy density of at least 4 kWh/kg. By using the lightest-possible materials for the housing and electrical components, the energy density can be designed appropriately so that the mobile storage device can readily be carried by a person.

According to one embodiment, it is proposed that the housing have a volume of between 1 and 3 dm³ and/or that the battery have a capacity of from 1 to 4 kWh.

According to one embodiment, it is proposed that a location-determining means be provided in the housing. This can be in particular a GPS or Galileo sensor. By means of the location-determining means, location data can be filed in the memory. Said data can preferably be stored with a time stamp so that, in conjunction with the previously mentioned information, it is possible to draw an accurate picture of the progression of the mobile storage device over time and in space.

According to one embodiment, it is proposed that the mobile storage device comprise a socket, and that said socket have a mechanical child safety device. In particular, the battery is characterised by a high energy density, and therefore protection against improper operation is required.

To prevent a short circuit, a fuse is provided between the battery and the power outlet. The fuse can monitor the voltage between the contacts at the power outlet and release said voltage as soon as a short circuit at the output has been eliminated.

As has already been mentioned, the mobile electric storage device can be used in particular as part of a deposit system. For this purpose, it is necessary for a plurality of mobile electric storage devices to be able to be charged as simultaneously as possible. This can take place for example by means of inductive charging. In particular, the charging can take place near a power station. For optimum inductive charging, it is necessary for as many mobile electric storage devices as possible to also be able to be arranged as closely together as possible side-by-side in the space. In order to arrange the mobile electric storage devices side-by-side, it is proposed that the housing comprise at least two outer walls extending in parallel with one another, and that said two outer walls have in particular complementary profiles. By means of this, a high packing density can be achieved, since a plurality of storage devices can also be stacked one on top of the other. In particular, the mobile storage device is configured in such a way that the outer edges thereof span a cube so that the mobile storage devices can be packed relative to one another with the highest possible packing density.

According to one embodiment, it is proposed that at least two mobile storage devices be able to be arranged side-by-side on a carrier system. A carrier system can be for example a carrier pallet, on which a plurality of mobile storage devices can be arranged side-by-side and/or one above the other. Said carrier system can be used for transporting the mobile storage devices between charging stations, in particular at the power station, and for retail. Storage devices which are taken back are stored side-by-side on the carrier system and subsequently transported to the charging station, in particular in the region of the power station, by means of the carrier system. At said charging station, automatic charging can take place in that the plurality of mobile storage devices are preferably inductively charged simultaneously on a carrier system.

To facilitate automatic charging, it is proposed that the electric storage devices be able to be automatically transported to a charging device by the carrier system. For this purpose, a guide projection can be provided on the bottom of the carrier system. By means of the guide projection on the bottom, a conveyor belt or a transport belt can receive the carrier system. Said conveyor belt or the transport belt can transport the carrier system to a charging device and guide said system out of the charging device so that the mobile storage devices, which are then charged, can in turn be transported to the deposit system.

To facilitate inductive charging, it is advantageous for the magnetic field to be influenced to only a limited extent by the material of the housing. This is achieved when the relative permeability μr at least of the housing wall of the mobile storage device on which the charging coil is arranged is between 0.9 and 1.1. In particular, the electric storage devices are arranged in a coordinated manner on the carrier system so that in each case the same housing wall, for example a bottom wall or a side wall of a storage device, faces the same wall of the carrier system.

To facilitate the charging by means of induction, it is expedient for all the storage devices to be oriented in the same manner on the carrier system, and thus for all the charging coils to accordingly be oriented in the same manner. For this reason, it is proposed that the electric storage devices each be arranged on the carrier system in such a way that the receiver coils of the power inlet each point in the same direction or are magnetically oriented in the same manner, in particular the surface normals of the effective coil surface point in substantially the same direction.

Furthermore, a method for charging a mobile storage device is proposed in which at least two mobile storage devices are arranged on the same carrier system, the carrier system is transported to a stationary charging device by a transport device, and the stationary charging device induces an alternating magnetic field simultaneously in the storage devices arranged on the same carrier, and a charging current is induced in the receiver coils of each mobile storage device by means of the alternating magnetic field.

The above-mentioned methods can also be implemented as a computer program or as a computer program stored on a storage medium. In this case, a microprocessor for carrying out the respective method steps can be programmed in a suitable manner by a computer program.

The features of the methods and devices can be freely combined with one another. In particular, features and partial features of the description and/or of the dependent and independent claims, even when bypassing all or some of the features or partial features of the independent claims, can be independently inventive when taken in isolation or when freely combined with one another.

### BRIEF DESCRIPTION OF THE SEVERAL VIEWS OF THE DRAWING

In the following, the subject matter will be described in greater detail with reference to drawings illustrating embodiments, in which:

FIG. 1 is a schematic block diagram of a mobile electric storage device according to one embodiment;

FIG. 2 is a schematic block diagram of a mobile storage device according to another embodiment;

FIG. 3 is a schematic view of a power outlet according to one embodiment;

FIG. 4 is a schematic view of a readable memory in a mobile storage device according to one embodiment;

FIG. 5a is a schematic block diagram of a battery in a mobile storage device;

FIG. 5b is a schematic block diagram of a storage cell module of a battery in a mobile storage device;

FIG. 6 is an external view of a mobile storage device according to one embodiment;

FIG. 7 is a plan view of mobile electric storage devices according to one embodiment;

FIG. 8 is a view of mobile electric storage devices comprising a carrier system according to one embodiment; and

FIG. 9 shows an automatic charging device for a plurality of mobile electric storage devices according to one embodiment.

### DETAILED DESCRIPTION OF THE INVENTION

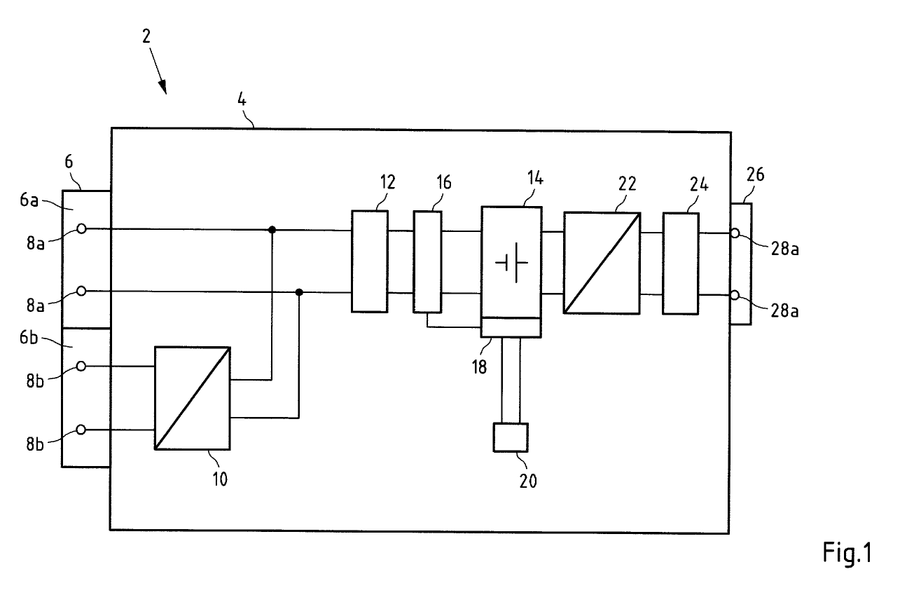

FIG. 1 is a schematic block diagram of a mobile electric storage device 2 comprising a housing 4. On the housing 4, a power inlet 6 is provided, which can be provided either in or on the housing 6. The power inlet 6 is formed by a DC voltage socket 6a and/or an AC voltage socket 6b. In the DC voltage socket 6a, two electrical contacts 8a are provided, by means of which an external power supply can be connected to a DC voltage. In the AC voltage socket 6b, two electrical contacts 8b are provided, by means of which an external AC voltage source can be connected to the mobile storage device 2.

Proceeding from the electrical contacts 8b, a rectifier 10 is provided inside the housing 4. The rectifier 10 converts the input AC voltage at the contacts 8b into a DC voltage, which preferably has the same standard voltage which is to be applied to the electrical contacts 8a of the DC voltage socket 6a. This can be as high as several hundred volts, depending on the possible charging speed of the mobile storage device 2.

To protect the electrical contacts 8a, 8b, said contacts are mechanically protected against contact.

Proceeding from the rectifier 10a and the electrical contacts 8a, a monitoring circuit 12 is provided. The monitoring circuit 12 monitors the direction of current flow from and to the electrical contacts 8a, 8b. By means of the monitoring circuit 12, it is possible for a current flow to be possible only from the electrical contacts 8a, 8b to the battery 14, but not back.

The monitoring circuit 12 is not necessarily possible only at the location shown. In fact, it is also possible that, alternatively or additionally, a monitoring circuit 12 is provided between the electrical contacts 8a and the output of the rectifier 10 so that when charging takes place via the electrical contacts 8b, the electrical contacts 8a are currentless. The same can also take place in the other direction, in that for example the rectifier 10 is provided with a monitoring circuit, or if a corresponding monitoring circuit is provided directly at the output of the rectifier 10.

At the output of the monitoring circuit 12, a charge controller 16 is connected, which is responsible for the charge management for the battery 14. The charge controller 16 is configured in such a way that the battery 14 can be charged with 10 C, preferably 20 C, more preferably 50 C, in particular 150 C. This allows the battery 14 to be charged very quickly. To quickly charge the battery 14, the electrical components at the input of the battery 14 are to be configured for high currents and/or high voltages, in particular high electrical outputs.

This means that the electrical contacts 8a, 8b, the rectifier 10, the monitoring circuit 12, and the charge controller 16 must all be configured for large electrical outputs. In particular, the components are configured for higher electrical outputs than the components which are provided at the output of the battery 14 and described in the following.

A sensor 18 is provided on the battery 14. The sensor 18 monitors the state of charge of the battery 14 and reports information about the battery 14 back to the charge controller 16. The charge controller 16 controls the charging current in accordance with the information about the battery 14.

Furthermore, the sensor 18 is connected to a display 20 which can be optical and/or acoustic. By means of the display 20, it is possible to signal to the user of the mobile storage device 2 whether or not the battery 14 still has sufficient charge.

An inverter 22 is provided at the output of the battery 14. The inverter 22 is configured in such a way that it inverts the DC voltage of the battery 14 into a predefined AC voltage. For this purpose, for example an AC voltage of 220 volts is suitable. In other regions, AC voltages of 230 volts or even 115 volts are also possible. The inverter 22 is configured according to the field of use of the mobile storage device 2.

At the output of the inverter 22, a fuse 24 is provided, which monitors the current from the battery 14 to the power outlet 26. The fuse 24 is preferably set to a maximum current of 16 amps, but other fuses 24 are also possible.

Via the power outlet 26, which preferably comprises electrical contacts 28a, electrical energy can be obtained from the mobile storage device 2. By corresponding configuration of the inverter 22 and the fuse 24, the same voltage having the same frequency as would be possible in a home distribution network is to be obtained at the electrical contacts 28. The mobile storage device 2 thus represents a power supply which is not dependent on location. By dimensioning the battery 14 accordingly, everyday necessities, such as using a hairdryer, using a vacuum cleaner, using lamps, using computers and the like can be made possible in any location and completely independently of a home distribution network.

In this case, the battery 14 is preferably dimensioned in such a way that it has a storage capacity of more than one kilowatt hour, preferably 1-4 kilowatt hours. By means of such a capacity, most domestic necessities can be used for a sufficient length of time.

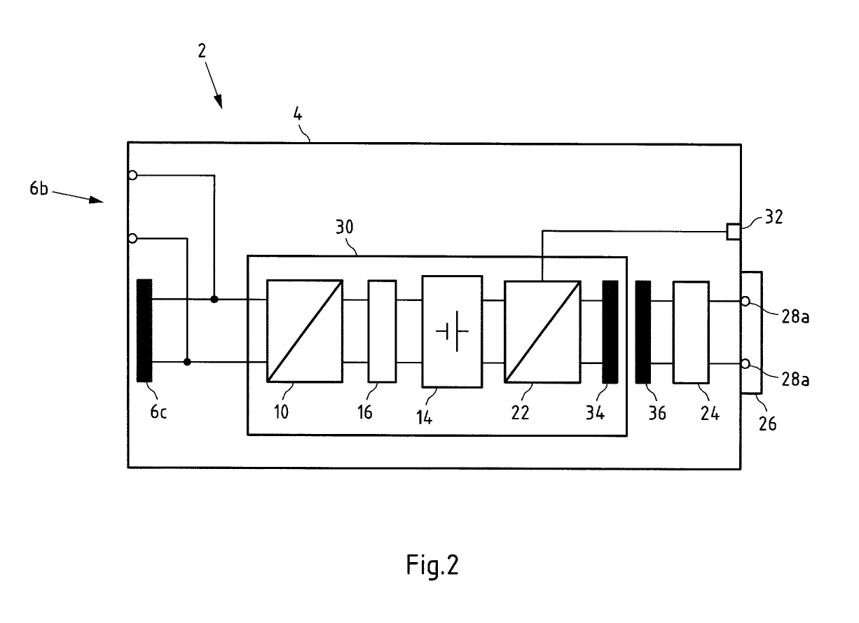

The housing 4 is preferably protected against splashing water, at least the battery 14 again being able to be protected in an isolated manner in the housing 4, as shown in FIG. 2.

FIG. 2 shows another embodiment of a mobile storage device 2. In this case as well, a DC voltage socket 6a is provided, but said socket is shown only for the sake of completeness and can also be emitted according to one embodiment. Furthermore, in comparison with FIG. 1, the AC voltage socket 6b is replaced by a receiver coil 6c. The receiver coil 6c is preferably arranged on an outer wall of the mobile storage device 2 or of the housing 4. The receiver coil 6c is configured to inductively charge the battery 14 and can be activated by means of an external transmitter coil (not shown) which is applied to the mobile storage device 2 and generates an alternating magnetic field in the region of the mobile storage device 2. Said transmitter coil can be arranged in a power station for example to charge a plurality of storage devices 2.

A charging current is induced in the receiver coil 6c by means of magnetic induction. The charging current is directed from the receiver coil 6c or the AC voltage socket 6b via electric wires into a second housing 30. The second housing 30 and the cable feedthrough on the second housing 30 are preferably better protected against water ingress than the housing 4. In particular, protection is carried out in accordance with protection classes IPX6, IPX7 or IPX8, which means protection against splashing water, brief immersion or continuous immersion.

The rectifier 10 is arranged inside the housing 30. However, said rectifier can also be provided outside the housing 30. Proceeding from the rectifier 10, the charge controller 16 is provided. In the embodiment shown in FIG. 2, for the sake of simplicity, the monitoring circuit 12 is not provided or not drawn in. The charge controller takes over the charging of the battery 14. For the sake of clarity, the sensor 18 is likewise not drawn in or can be omitted.

The inverter 22 is arranged at the output of the battery 14. The inverter 22 can be activated and deactivated as required by means of a suitable control unit. For this purpose, a sensor 32, which is for example a proximity sensor 32, can feed a control signal into the inverter 22. The proximity sensor 32 can monitor whether an object, for example a plug, is in the vicinity of the mobile storage device 2 or of the power outlet 26. The inverter 22 can be activated only in the case where an object, in particular a plug, has been detected by the proximity sensor 32. For this purpose, the proximity sensor 32 is preferably arranged in such a way that it preferably detects only the presence of a plug at the power outlet 26. The proximity sensor 32 is therefore arranged preferably in or in the immediate vicinity of the power outlet 26. Erroneous activations of the inverter 22 can thus be kept to a minimum, in that only the presence of a plug is detected, but not for example the presence of a hand. The proximity sensor can therefore for example also be configured in such a way that it detects only objects which have a metal content.

As soon as the inverter is activated, an AC voltage is present at the output thereof. The AC voltage is firstly supplied to a transmitter coil 34. The magnetic field generated by the transmitter coil in turn induces a current in a receiver coil 36. By means of the transmitter coil 34 and the receiver coil 36, galvanic decoupling takes place between the output of the battery 14 and the electrical contacts 28 of the power outlet 26.

By means of the merely magnetic coupling between the transmitter coil 34 and the receiver coil 36, the housing 30 can be sealed very well in order to comply in particular with the stipulated protection classes.

At the output of the receiver coil 36, the fuse 24 is connected, which then transfers the alternating current to the power outlet 26.

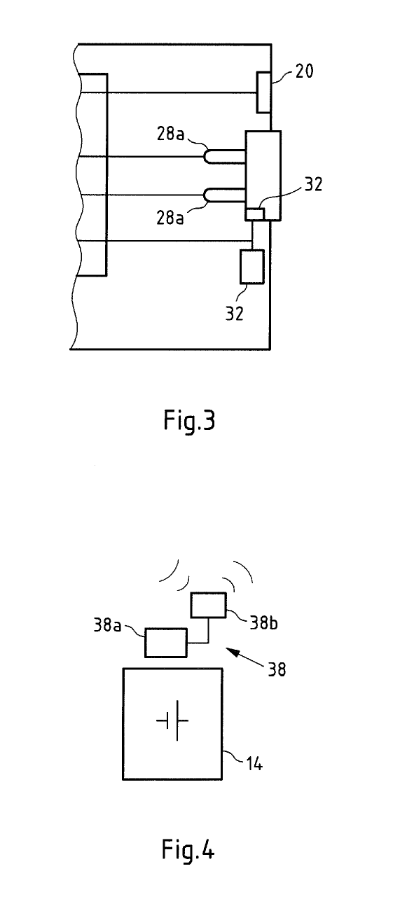

FIG. 3 is a schematic view of a detail in the region of a power outlet 26. In FIG. 3, the power outlet 25 can be in the form of a Schuko socket but can also be in another form. The electrical contacts 28a are also formed as receptacles which can receive contact pins of Schuko plugs. In the region of the socket of the power outlet 26, the proximity sensor 32 can be provided. Alternatively or additionally, an additional proximity sensor 32 can be provided outside the power outlet 26. By means of the proximity sensor 32, it is possible to detect the presence of a plug, and this signal, as described above, is directed into the inside of the housing 30 and processed accordingly therein. Preferably, this is used to control the inverter 32. The signal can also be used to open or close a switch between the battery 14 and the transmitter coil 34 to thus control a magnetisation of the transmitter coil 34 according to the presence of an object in the region of the proximity sensor 32.

Furthermore, the display 20 is shown, which indicates the charging status of the battery 14 to the user and is connected to the sensor 18.

The mobile storage device 2 is preferably to be configured in such a way that it is charged near a power station by an operator, is provided to customers by retail, and is subsequently taken back again to be recharged. By means of this, a circuit system is to be provided, by which the mobile storage device 2 can be provided to the customer in such a way that it can be used multiple times. A corresponding deposit system can be set up. To make this deposit system possible, it is helpful for the operator to have knowledge about the state of the mobile storage device 2 or of the battery 14, the usage history thereof and the position information thereof.

For this reason, as is indicated in FIG. 4, a memory 38 which can be read remotely is provided on the battery 14, in particular inside the housing 4, in particular inside the housing 30, which memory is formed of a memory bank 38a and a transceiver module 38b. In addition to the transceiver module 38, a position sensor (not shown) can be connected to the memory 38. Said position sensor can be for example a GPS or Galileo sensor and supply position data provided with a time stamp to the memory 38.

Preferably, all the data in the memory 38 are stored with time stamps so that temporal correlations between the stored data can be identified.

In the memory 38, for example the state of charge of the battery 14, which is detected by the sensor 18, is stored at intervals for this purpose. In this case, for example the discharging process as well as the charging process of the battery 14 can be monitored. Depending on whether the charge controller 16 is activated or not, which can also be stored in the memory 38, changes in the state of charge of the battery 13 are detected. In this case, for example the charging voltage and the charging current can also be detected. When discharging the battery 14, that is to say when the inverter 22 is activated, the state of charge and the discharging current and discharging voltage can also be monitored continuously and filed in the memory 38.

Furthermore, the number of charging cycles of the mobile storage device 2 can be stored in the memory 38. The duration of individual charging cycles can also be stored in the memory 38. Furthermore, a unique identification of both the mobile storage device 2 and the battery 14 can be stored in the memory 38. This can be for example firstly a MAC address of the memory 38, and for the battery 14, this can be a unique identification.

All the information stored in the memory module 38a of the memory 38 can be read contactlessly by means of the transceiver module 38b. Data can also be fed into the memory module 38a by means of the transceiver module 38b. In this case, for example information about the users carrying out a charging process can be stored. This can be expedient for example when the mobile storage device 2 is used in a circuit system, and different participants take over the charging process. If who is currently charging the mobile storage device 2 is stored, damage as a result of improper charging can be attributed to a participant. It is also possible to detect whether, when charging, the user themselves attempted the charging process, in which case in particular no identification of the participant who is charging is available or stored, or whether the charging is being carried out by an authorised participant, since then the participant does enter a corresponding identification into the memory module 38a. If the battery 14 is damaged for example as a result of a charging attempt by the user, this can be tracked, since the charging information is then available in the memory 38 without information about an authorised charging participant being filed in the memory 38 at the same time.

The transceiver module 38b can be a near-field communication module or a far-field communication module. In this case, for example NFC and Bluetooth are suitable as near-field communication means. However, the transceiver module 38b can also address a wide area network, in particular a mobile communications network or another wireless network, for example WLAN, and can thus be read remotely. A combination of near-field and far-field communication can also be possible, in particular near-field communication can be useful when an authorised participant is charging in order to be able to read a plurality of mobile storage devices 2 in the shortest possible period of time. For this purpose, the mobile storage device 2 is guided together with a plurality of other mobile storage devices 2 through a reading field, which allows a plurality of mobile storage devices 2 to be read very quickly.

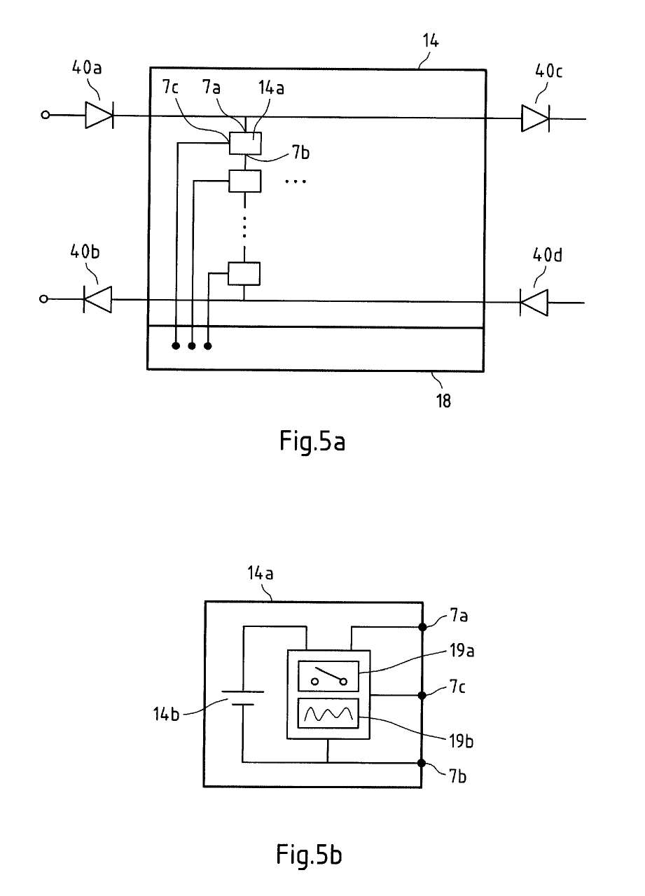

FIG. 5a is a schematic view of a battery 14 comprising a plurality of storage cell modules 14a. A plurality of the storage cell modules 14a are preferably connected in series, and subsequently a plurality are connected in parallel. By means of the number of storage cell modules 14a in series, the output voltage of the battery 14 can be adjusted, and the number of all the storage cell modules 14a, taking into consideration the sections connected in parallel, provides the storage capacity. A storage cell module 14a has in each case an input contact 7a, an output contact 7b, and a balancing contact 7c.

By means of diodes 40a-d, the direction of current flow towards the battery 14 during charging and discharging can be controlled so that a charging current firstly flows exclusively into the storage cell modules 14a of the battery 14. In addition, a reverse current from the battery 14 to the power outlet 6 can be prevented.

In a preferred embodiment, a sensor 18 is connected to at least two of the balancing connections 7c of at least two storage cell modules 14a. It is shown that the balancing connections 7c are each guided to the sensor separately. Of course, it is also possible for the balancing connections to be guided together via a bus line.

FIG. 5b is a schematic view of a storage cell module 14a. In said storage cell module 14a, a storage cell 14b is provided. A positive pole of the storage cell 14b is protected by a circuit breaker 19a. The circuit breaker 19a can be built into an individual sensor 18a of a cell. By means of the circuit breaker 19a, the positive pole of the storage cell 14b is connected to the connection 7a. The circuit breaker 19a can be for example a thermal circuit breaker.

Furthermore, a balancer circuit 19b for protecting the storage cells and for balancing the charging capacity of all the storage cells 14b of the battery 14 can switch the circuit breaker 19a on or off.

In the embodiment shown here, the storage cell guides the negative pole thereof to the electrical contact 7b. The balancing connection 7c is used to balance charging and/or for communication purposes. Said connection can be connected to the sensor 18 separately for each storage cell module 14a or guided together on a bus line.

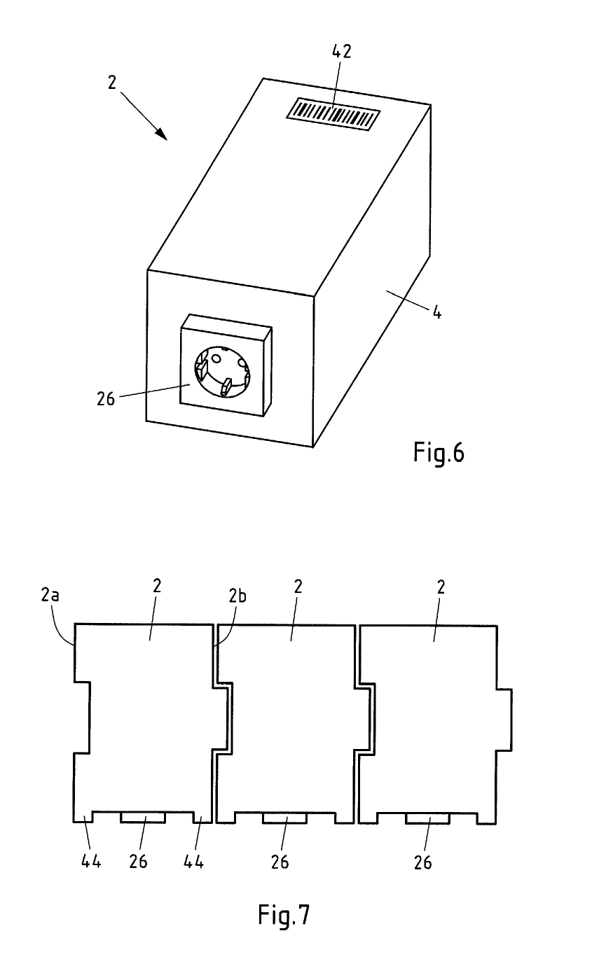

FIG. 6 is an external view of a mobile storage device 2. The housing 4 is preferably cubic, having side walls extending preferably in parallel with one another. A barcode 42 can be applied to the housing 4, by which the storage device 2 can be uniquely identified by means of a scanner (not shown). It can be seen that, on one surface, the power outlet 26 is in the form of a Schuko socket. It is also possible for the power outlet 26 to be in the form of a socket in accordance with the British standard or another standard. In particular, however, the power outlet 26 is in the form of a standardised socket. Preferably, the power outlet 26 is in the form of a low-voltage socket.

In order to configure a deposit system as efficiently as possible, the mobile storage devices 2 must be easy to transport and easy to charge together. For this purpose, it is advantageous for the mobile storage devices 2 to be able to be stacked easily so that they can be transported on the same carrier systems.

FIG. 7 is a plan view of densely packed storage devices 2. In this case, it can be seen that in each case two mutually opposed side walls 2a, 2b have complementary profiles. In FIG. 7, said profiles are a recess and a protrusion respectively. By means of this, a plurality of mobile storage devices 2 can be arranged side-by-side in a particularly simple manner. To prevent the mobile storage devices 2 from tilting in the region of the power outlet 26, it is provided that protrusions 44 are provided on each of the side walls on which the power outlet 26 is provided. The protrusions 44 are formed so as to end in a plane with the end face of the power outlet 26 so that the mobile storage devices 2 can be stacked one behind the other without tilting in the region of the power outlet 26.

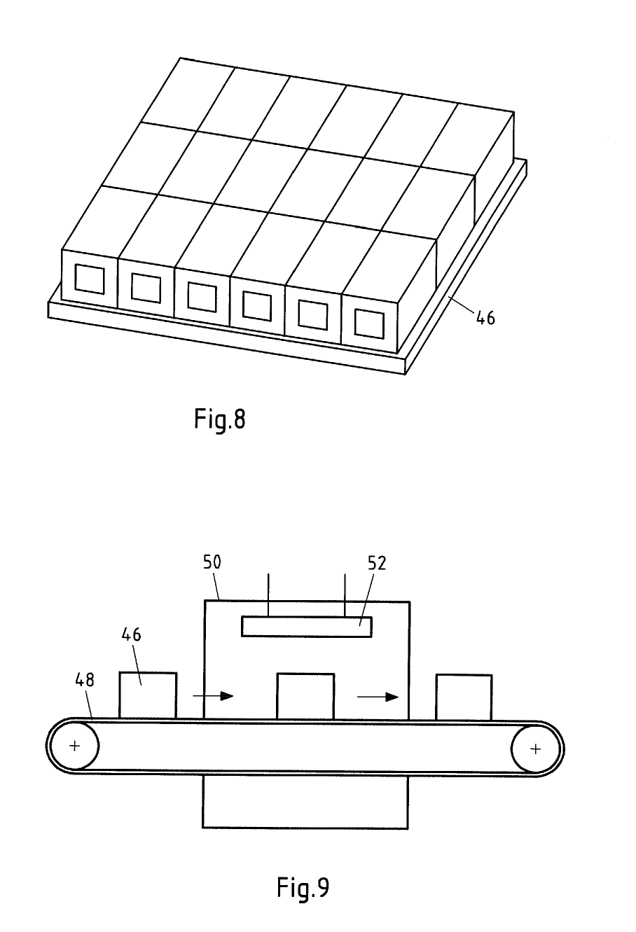

FIG. 8 shows a plurality of mobile storage devices 2 on a carrier system 46. By means of the design of the housing 4 shown in FIG. 7, the mobile storage devices 2 can be stacked side-by-side very easily, and a high packing density can be achieved. By means of the transport system 46, the storage devices 2 can be mounted and transported one above the other in a plurality of layers, and side-by-side in a plurality of columns and rows. When mounting the mobile storage devices 2 on the transport system 46, it is provided that the mobile storage devices 2 are each oriented in the same manner so that the receiver coils 6c of all the mobile storage devices 2 point in the same direction. Preferably, the effective surface of the receiver coils 6c, that is to say the surface normals thereof to the effective coil surface, are inclined relative to the transmitter and receiver coils 34, 36 or the surface normals thereof to the effective coil surface, preferably at a right angle to one another, so that the magnetic field, which is used to charge the batteries 14, penetrates the receiver coil 36 and transmitter coil 34 in only a very small magnetically effective surface.

By means of a directed magnetic field, which penetrates the carrier system 46 in one direction as far as possible, all the receiver coils 6c of all the mobile storage devices 2 are magnetised as uniformly as possible, and the induced voltages are used to charge the batteries 14. If the receiver coil 6c and the transmitter coil 34, as well as the receiver coil 36, are inclined relative to one another, preferably with the magnetically effective surfaces thereof perpendicular to one another, the magnetic field for charging flows preferably flows through only the receiver coils 6c, and through the transmitter coil 34 and the receiver coil 36 to only a limited extent.

By means of the transport system 46, mobile storage devices can be placed, on palettes, as shown in FIG. 9, on conveyor belts 48 and taken away. This occurs preferably in the case of a participant of the circuit system which is responsible for charging. The transport systems 46 are transported by the conveyor belt 48 into a charging chamber 50, which preferably represents a shield for electromagnetic radiation. By means of an electromagnet 52, an alternating magnetic field can be generated in the charging chamber 50, which field flows through the mobile storage devices 2 mounted on the transport system 46 and induces charging currents in each case by means of the receiver coils 6c.

The conveyor belts 48 and charging chambers 50 are preferably arranged in the region of a large-scale power station so that the charging current can be provided directly, without using an electric power distribution network. After a charging process, the mobile storage devices are moved from the conveyor belt 48 to the ejection point, where said devices are removed from the conveyor belt 48. Both at the injection point and at the ejection point of the charging chamber 50, near-field readers (not shown) can be provided, which read all the information from all the mobile storage devices 2 or the memories 38 thereof in a short period of time and, where necessary, indicate a replacement of mobile storage devices 2.

By means of the system shown, it is possible, in a circuit system, to provide mobile storage devices for electrical energy in which the electrical energy can be provided independently of a distribution network. This offers the advantage that, irrespective of the construction of electric power distribution networks, electrical energy can be provided to customers cost-effectively and conveniently.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A mobile electric storage device, comprising
a housing,
a battery which is arranged in the housing,
an inverter which is arranged in the housing and electrically connected to the battery,
a power outlet which is arranged in the housing and electrically connected to the inverter,
a charge controller which is arranged in the housing and connected to the battery,
a power inlet connected to the charge controller,
wherein the power inlet and the charge controller are configured for higher electrical outputs than the inverter and the power outlet.

2. The mobile electric storage device according to claim 1, wherein the battery is a lithium-ion battery, a lithium polymer battery or a metal-air battery, in particular a zinc-air battery or an aluminium-air battery.

3. The mobile electric storage device according to claim 1, wherein the power outlet is a socket, in particular a Schuko socket.

4. The mobile electric storage device according to claim 1, wherein a rectifier is arranged in the housing, in that the rectifier is electrically connected to the charge controller, and in that the power inlet is connected to the rectifier.

5. The mobile electric storage device according to claim 1, wherein the power inlet is an electrical contact socket, in particular in that the power inlet is a direct current inlet.

6. The mobile electric storage device according to claim 1, wherein at least the battery, in particular also the inverter and/or the discharging coil is enclosed in a moisture-tight manner in an enclosure inside the housing, in particular in accordance with IPX7 or IPX8 or IPX9 according to DIN EN 60529, and/or in that the battery is protected against an electrical short-circuit inside the enclosure.

7. The mobile electric storage device according to claim 1, wherein the power inlet is in the form of an inductive receiver coil, in such a way that the receiver coil contactlessly receives electrical energy from outside the electric storage device and transfers said energy to the charge controller, in particular in that galvanic decoupling is brought about between a power supply outside the mobile storage device and the charge controller by means of the receiver coil.

8. The mobile electric storage device according to claim 1, wherein the power outlet comprises an inductive transmitter coil and an inductive receiver coil which is inductively coupled to the transmitter coil, the transmitter coil being electrically connected to the inverter, and in that the receiver coil is connected to an electrical contact on the housing in such a way that the electrical contact is galvanically isolated from the inverter.

9. The mobile electric storage device according to claim 1, wherein a sensor is configured to contactlessly detect an energy-extraction means arranged on the housing, only a detection of the extraction means by the sensor bringing about the electrical activation of the discharging coil.

10. The mobile electric storage device according to claim 1, wherein a state-of-charge indicator for indicating the state of charge of the battery is arranged on the housing.

11. The mobile electric storage device according to claim 1, wherein a contactlessly readable memory is arranged in the housing, and in that, in the memory, at least one item of information about
a) the state of charge of the battery,
b) the number of charging cycles of the battery,
c) the duration of the charging cycles of the battery,
d) the electrical energy discharged by the battery,
e) a progression of position data of the mobile storage device,
f) a unique address of the mobile storage device,
g) a storage capacity of the battery,
h) a unique identification of the battery and/or of the memory is stored, and in that at least one of these items of information is contactlessly read from the memory.

12. The mobile electric storage device according to claim 1, wherein the power outlet is configured for electrical outputs of up to 3 kW and/or in that the power outlet is configured for electrical outputs of at least 20 kW, preferably at least 50 kW, in particular at least 75 kW, and/or in that the charge controller is configured for charging with up to 150 C.

13. The mobile electric storage device according to claim 1, wherein a current flow sensor at the power inlet monitors a direction of current flow.

14. The mobile electric storage device according to claim 1, wherein a switch is arranged at the power outlet, and in that the switch breaks the electrical connection between the power outlet and the inverter when a power flow from the power outlet to the inverter is detected by a current flow sensor.

15. The mobile electric storage device according to claim 1, wherein
the battery and the housing are configured in such a way that the storage device has an energy density of at least 4 kWh/dm³ and/or
the battery and the housing are configured in such a way that the storage device has an energy density of at least 4 kWh/kg.

16. The mobile electric storage device according to claim 1, wherein the housing has a volume of between 1 and 3 dm³ and/or the battery has a capacity of from 1 to 4 kWh.

17. The mobile electric storage device according to claim 1, wherein a location-determining means, in particular a GPS or Galileo sensor is arranged in the housing, and in that the location-determining means stores location data in a memory.

18. The mobile electric storage device according to claim 1, wherein a mechanical child safety device is integrated in the socket of the power outlet.

19. The mobile electric storage device according to claim 1, wherein a fuse is provided between the battery and the power outlet.

20. The mobile electric storage device according to claim 1, wherein the housing comprises at least two outer walls extending in parallel with one another, and in that the two outer walls have complementary profiles.

21. A system comprising at least two mobile electric storage devices according to claim 1 and a carrier system, wherein the electric storage devices are arranged side-by-side on the carrier system.

22. The system according to claim 21, wherein the carrier system comprises guide projections on the bottom thereof in such a way as to be received by a conveyor belt or a transport belt.

23. The system according to claim 21, wherein the carrier system is formed on at least one wall facing the electric storage devices, which wall is made of a material having a relative permeability μr of between 0.9 and 1.1.

24. The system according to claim 21, wherein the electric storage devices are each arranged on the carrier system in such a way that the receiver coils of the power inlet each point in the same direction.

25. A method for charging a mobile storage device according to claim 1, comprising the steps of:
arranging at least two mobile storage devices on the same carrier system,
transporting the carrier system to a stationary charging device by a transport device,
wherein the stationary charging device induces an alternating magnetic field simultaneously in the storage devices arranged on the same carrier, and a charging current is induced in the receiver coils of each mobile storage device by means of the alternating magnetic field.
